(19) United States
(12) Patent Application Publication
(10) Pub. No.: US 2011/0244077 A1
(43) Pub. Date: Oct. 6, 2011

(54) Process and system for delivering fresh yogurt or kefir

(76) Inventors: Felix Belferman, Fair Lawn, NJ (US); Rafael Danon, Fair Lawn, NJ (US)

(21) Appl. No.: 12/798,550

(22) Filed: Apr. 6, 2010

(51) Int. Cl. A23C 9/127

(52) U.S. Cl. 426/43

(57) ABSTRACT

A process for delivering to a retail location freshly prepared ‘Grade A’ yogurt or kefir with full undiminished concentration of probiotic microorganisms provides health benefits to customers. The yogurt manufacturing facility mixes cooled sterilized milk with a yogurt culture with low growth at 4° C. to 10° C. forming yogurt mixture fills and seals yogurt containers. Alternatively, the cold milk is separated from any yogurt or kefir culture in the yogurt container by a separation portion. The yogurt containers are then shipped cold to retail locations. The retail location stores yogurt containers at low temperature prior to incubation. When needed, the yogurt container is shaken to mix milk and separated yogurt or kefir culture. The yogurt containers are transferred to incubation oven for appropriate time to set yogurt or kefir, which is then refrigerated for sale to customers.

### BACKGROUND OF THE INVENTION

1. Field of the Invention

The present invention relates to the manufacture and distribution of yogurt; and, more specifically, to a process and system for delivering freshly cultured yogurt or kefir containing a high concentration of active cultures at a retail location.

2. Description of the Prior Art

Many patents address issues related to producing yogurt or kefir. These patents disclose processes that produce yogurt or kefir and seal the containers at the factory. Cold yogurt containers are then shipped to retail stores for sale to customers from a refrigerated display systems. The yogurt manufacturing facility uses a variety of yogurt or kefir forming cultures. Each culture requires a specific combination of incubation temperature and incubation time. The final yogurt product stored in a refrigerator is subject to degradation and generation of foul taste and stringy structure due to continued growth of cultures in the yogurt and other contaminant micro-organisms at the storage temperature. The concentration of health promoting active cultures in the yogurt or kefir decreases as a function of storage time and the customer does not receive the full benefit of these cultures. None of the prior art disclosures creates a yogurt or kefir product in a sealed container at the selling location to thereby provide a fresh yogurt or kefir product that has an undiminished concentration of active cultures.

U.S. Pat. No. 1,710,133 to Gustov Winkler discloses a process for preparation of mild aromatic yoghurt, curdled milk or a sweet yoghurt junket. The yoghurt produced has a lower degree of acidity than normal yoghurt. Milk is boiled and sterilized, cooled to 28° C. to 32° C. and is inoculated with mixed culture of cocci bacteria, rennet bacteria micrococcus lactis acidi lohnis and yeast of the torula and myciderma group that neither produces alcohol or carbonic acid. The yogurt is curdled in a period of 4 to 6 hours. This yogurt or kefir is produced at the factory not at the retail sale location.

U.S. Pat. No. 2,119,599 to Nordsiek discloses a milk product and process of manufacturing the same. Milk is heated to sterilize at 99° C., cooled to 40° C. and is immediately inoculated with Streptococcus thermophiius 4915 and Lactobacillus acidophilus, and fermented for 5 to 7 hours. This yogurt culture is immediately added to the 40° C. sterilized milk at the milk product producing factory.

U.S. Pat. No. 3,128,190 to Donay et al. discloses a method of making combined fruit yogurt. The milk, with sweeteners is heated to at least 96° C. (205° F.) and is cooled to 37.7° C. (100° F.). This patented process uses lactobacillous bulgaricus incubated at 36.6° C. to 37.7° C. (98° F. to 100° F.). Since the lactobacillous bulgaricus is immediately added after cooling, the frit yogurt is incubated at the factory.

U.S. Pat. No. 3,563,760 to Kuwabara et al. discloses the production of fermented milk product. Sterilization is needed to get rid of yeast. First milk is fermented with yeast at 25° C. to 30° C. for 15 to 20 hours, sterilized at 100° C. and then fermented with yogurt culture at 25° C. to 30° C. until acidity level is reached. Fermentation by yeast is said to prevent alcohol separation. The yogurt cultures include Lactobacillus acidophilus, Lactobacillus bulgarucus, Lactobacillus casei, Streptococcus thermophillus or Streptococcus diacetlactis. The yogurt fermentation occurs at a central factory location due to the fermentation temperature requirements.

U.S. Pat. No. 4,210,672 to Hata discloses preparation of yogurt. Yogurt is prepared with a mixture of milk powder and novel Lactobacillus thermophilus (also known as bacillus coagulans) spores that have specific characteristics of requiring nourishment at the time of spore formation, being capable of high speed acid formation, taking a short time for transition into germ cells after budding and being highly thermobiotic so as to kill or inhibit during yogurt fermentation the growth of undesirable saprophytes including spore forming saprophytes present in yogurt which serve to putrify or spoil the yogurt. To prepare yogurt, boiling water is added to the mixture to kill or inhibit the growth of saprophytes and the mixture is permitted to ferment for a relatively short period of time. The spores of yogurt microbes can tolerate boiling at 100° C. and ferment the yogurt at 50° C. within 5 hours. The spores are sporiferous lactic acid bacteria of type Bacillus EC-1, Species No. 2,930. Boiling water is added to milk powder and this high temperature sterilization and fermentation prevents the growth of saprophytes which cause purification of the yogurt. The yogurt culture is not a standard yogurt forming culture and is not fermented at 38° C. to 42° C.

U.S. Pat. No. 4,339,464 to Vedamuthu discloses a stabilizer producing Streptococcus thermophilus. Naturally stabilized fermented milk products are prepared with a concentrate of Streptococcus thermophilus cells that produce a stabilizer in situ when cultured in milk. The concentrate is obtained by culturing the stabilizer-producing Streptococcus thermophilus in a growth medium including milk solids to obtain at least about 108 cells per ml. The growth medium preferably contains maltose, sucrose, fructose or lactose, which enhances stabilizer formation. This stabilizer producing Streptococcus thermophilus is a starter culture and does not produce a yogurt.

U.S. Pat. No. 4,382,097 to Vedamuthu et al. discloses a method for the preparation of naturally thickened and stabilized fermented milk products and products produced thereby. A method for the preparation of naturally stabilized, thick bodied, fermented milk products by fermentation is described and uses mixed cultures of milk fermenting, non-slime, lactic acid producing bacteria and slime producing Streptococcus lactis, Streptococcus cremoris or mixtures thereof in milk. Streptococcus cremoris NRRL-B-12,361, 12,362 or 12,363 are used, preferably in addition with a diacetyl producing bacterium for flavor. The fermented milk products are thick bodied without any ropiness or sliminess and are stable to separation of whey from curd upon storage at refrigeration temperatures, with little or no added stabilizing agents such as gums and starches or thickening agents such as added non-fat milk solids. The preferred product is a thick-bodied buttermilk. The yogurt has a pH of 4.2 to 4.7. The inoculated milk is fermented with the mixed culture at temperature between about 10° C. to 32° C., preferably 24° C. The fermentation is generally conducted for between about 12 to 18 hours. The milk usually contains less than nine percent (9%) milk solids. The yogurt is not indicated to be freshly fermented at the yogurt dispensing retail location.

U.S. Pat. No. 4,410,549 to Baker discloses preparation of a low calorie, low fat fruit-containing yogurt. A low calorie, low fat fruit-containing yogurt is prepared by a process including steps of admixing skim milk, stabilizers and an amount of heat modified nonfat dry milk solids effective to improve texture and flavor, and processing the mixture by heating, homogenizing, fermenting with a culture mixture of Lactobacillus acidophilus, Lactobacillus bulgaricus and Streptococcus thermophilus, blending with low calorie fruit preserves and cooling. The heat modified nonfat dry milk solids are derived from a process in which condensed skim milk is subjected to non-coagulative direct steam heating prior to spray drying. The resultant yogurt product has the appearance, texture and taste of conventional fruit-containing yogurt. In this process, the low fat milk with dry milk solids is heated 87.7° C. to 90.6° C. to sterilize the milk, cooling the homogenized mixture to 32.3° C. to 48.9° C. adding immediately yogurt cultures of 0-50% Lactobacillus acidophilus, balance Lactobacillus bulgaricus and Streptococcus thermophilus in approximately equal proportions fermenting until pH reaches 3.8 to 4.8 and cooling to 1.6° C. to 9.4° C. (35° F. to 49° F.). The yogurt is homogenized with fruits. Due to the immediate addition of yogurt cultures to cooled milk and the homogenization of the yogurt with fruit, the yogurt is made at the yogurt manufacturing facility.

U.S. Pat. No. 4,416,905 to Lundstedt et al. discloses a method of preparing cultured dairy products. A method for the production of cultured dairy products, such as buttermilk, yogurt or sour cream, by the controlled fermentation of a liquid medium consisting of a major portion of light cream, milk, low-fat milk or skim milk or reconstituted skim milk powder or buttermilk powder, or a mixture of these two components. The liquid medium is fermented using a bacterial fermentation culture. The fermentation of the medium is allowed to proceed for sufficient time to achieve a pH in the range of between 6.2 to about 4.9, at which point the liquid medium is then cooled to a fermentation rate-reducing temperature and acidulated to a pH of 4.7 or below using food grade acids such as those selected from the group consisting of lactic, citric or acetic acid. The yogurt aciditity is provided by adding acid additives. This yogurt is produced at the yogurt manufacturing facility.

U.S. Pat. No. 4,425,366 to Sozzi et al. discloses production of yogurt. Yogurt having a reduced increase in acidity and bitterness during storage at ambient temperature is produced by fermenting milk with Streptococcus thermophilus and a Lactobacillus bulgaricus strain which has low proteolytic activity and allows a DNA-DNA hybridization of from 80 to 100%. A thickening strain of Streptococcus thermophilus may be used. The yogurt may be packed under sterile conditions and stored at about 20° C. The milk is fermented with a combination of strains in which the Lactobacillus bulgaricus strain has a low proteolytic activity and allows a level of DNA-DNA hybridization of from 80 to 100% with one of the strains of L. bulgaricus CNCM I-179, I-180 and I-181. Some strains of Lactobacillus bulgaricus possess the property of ceasing to produce lactic acid at a pH, which is higher than normal, notably at a pH approaching 5. Moreover, it is known that Streptococcus thermophilus produces lactic acid very rapidly, but stops production at a pH approaching 4.5. It was then found that a combination of Lactobacillus bulgaricus which ceases acidification at a pH approaching 5 and of Streptococcus thermophilus allowed the production of a yogurt having improved keeping properties with respect to increase in acidity and bitterness. The yogurt produced can be stored at 20° C. due to the low acid production capability possessed by special yogurt cultures of Lactobacillus bulgaricus and Streptococcus thermophilus. This yogurt is fermented in a factory.

U.S. Pat. No. 4,734,361 to Murao et al. discloses a low temperature-sensitive variant of Lactobacillus bulgaricus and a selection method therefor. The novel variant Lactobacillus bulgaricus sensitive at a lower temperature, that is, showing a weak tendency towards formation of lactic acid in a range of the lower temperature, and the method for the selection of the variant, are disclosed. By employing the variant, it is possible to produce a fermented milk or lactic acid beverage in which the rate of increase in the sour taste after preservation at a lower temperature is significantly lowered. The yogurt is produced by a low temperature variant of Lactobacillus bulgaricus.

U.S. Pat. No. 4,748,026 to Keefer et al. discloses process for production of a no-starch shelf stable yogurt product. This invention provides a method for producing shelf-stable yogurt product which exhibits a smooth, non-gritty texture and enhanced storage stability and the yogurt product produced by such a method. A yogurt product that is storage stable is that which does not have to be refrigerated, i.e., can be stored at room temperature for a period in excess of a few weeks without undergoing spoilage or a substantial breakdown in texture. Incubation is effected by inoculating the pasteurized dairy base within the temperature range of 35° C. to 46.1° C. (95° F. to 115° F.) with a culture of a yogurt producing microorganism, for example, streptococcus thermophilus and Lactobacillus bulgaricus. The microorganisms are allowed to incubate until the pH of the yogurt product is about 3.5 to 5.0. Preferably, the pH of the yogurt is about 4.2 to 4.3, a result obtained after about 3 to 4 hours of incubation. This long term stability is achieved by first pasteurizing/denaturing the milk proteins of the dairy base by high temperature treatment followed by fermentation at 37.8° C. to 46.1° C. (100° F. to 115° F.) to produce a yogurt. The yogurt, at fermentation temperatures is then mixed with a starch free group of thickeners and other additives comprising at least one calcium binding vegetable gum. The admixed yogurt product is then subjected to a pre-conditioning or denaturation step at temperatures within the range of about 54.4° C. to 65.6° C. (130° F. to 150° F.), homogenized, and pasteurized. The yogurt contains vegetable gum. The yogurt is pasteurized and the beneficial yogurt cultures are thus killed.

U.S. Pat. No. 4,797,289 to Reddy discloses enhancement of Lactobacillus acidophilus growth and viability in yogurt and other cultured dairy products. Lactobacillus acidophilus or bifidus does not grow and survive in yogurt for a long period of time. A differential inoculation procedure has been developed whereby Lactobacillus acidophilus is first inoculated into heat treated milk or milk-sugar-fiber base and incubated until its population builds up sufficiently.

Later, the regular yogurt cultures Streptococcus thermophilus and Lactobacillus bulgaricus are inoculated into the acidophilus growing yogurt mix. This procedure enables making of a yogurt with significantly high concentration of L. acidophilus bacteria in yogurt. Also dietetic fiber was introduced into the fruit base and then mixed with yogurt, which enhances the population of L. acidophilus and thickens the yogurt due to its exceptional hydration properties. Vitamins and minerals are also included into the yogurt both to enhance the population of acidophilus and to supplement the yogurt. Variations of using lactase enzyme to decrease the lactose in yogurt and to enhance the L. acidophilus counts have been employed. In addition, to significantly prolong the viability of L. acidophilus, calcium carbonate and catalase-L have been included in the yogurt. The milk is first fermented with slow growing micro organisms of Lactobacillus acidophilus or bifidus followed by fermentation with usual yogurt culture of Streptococcus thermophilus and Lactobacillus bulgaricus. The yogurt produced has slow growing Lactobacillus acidophilus or bifidus and has several additives including fiber, vitamins and calcium catalase-L. This yogurt is not free from additives and is not indicated to be produced in a retail location.

U.S. Pat. No. 4,837,036 to Baker et al. discloses a low fat thin-bodied yogurt product and method. A low calorie, low fat, high total solids, high protein content, thin-bodied, fruit-containing yogurt product is prepared by a process including the steps of admixing a butterfat-containing milk product in sufficient amount to provide a butterfat content in the yogurt product of less than about 0.5% by weight, limited quantities of a stabilizer mix, a nutritive sweetener, and non-heat modified nonfat dry milk solids. The mixture is processed by homogenizing, vat pasteurizing, fermenting with a uniquely proportioned three component bacterial yogurt culture mixture consisting essentially of, by weight, 15 to 25% Lactobacillus acidophilus, 30 to 50% Lactobacillus bulgaricus and 30 to 50% Streptococcus thermophilus, blending with low caloric, nutritive sweetener-containing fruit preserves and cooling. The resultant fruited yogurt product has a total solids content of 21.9 to 23.9%, a protein content of at least 4.5%, a caloric content of 150 calories per 6 ounce (170 gram) serving; the body, texture and taste of conventional thin-bodied fruit-containing yogurt. It is resistant to syneresis and exhibits a consumer acceptable appearance characterized by the absence of free moisture on the product surface and within the packaging. The low fat milk with dry milk solids is sterilized at 87.7° C., cooled to 32.2° C. to 48.9° C. and inoculated with 15 to 25% Lactobacillus acidophilus, 30 to 50% Lactobacillus bulgaricus and 30 to 50% Streptococcus thermophilus, and filtered through a screen to produce homogenous custard like yogurt. The yogurt containers are not closed prior to fermentation of the yogurt. The setup of filtration requires the yogurt to be produced at a factory.

U.S. Pat. No. 4,957,752 to Ivanova et al. discloses a process for producing kefir. This process for producing kefir involves normalization of purified cow milk with respect to the content of dry solids by ultrafiltration of the milk at a temperature of 50° C. to 55° C. until the content of dry solids is increased in the normalized milk by 0.5 to 4.0% by mass, further heat treatment at the temperature of 90° C. to 140° C., introduction into the normalized milk of a leaven prepared using kefir fungi, leavening of the resulting mixture to a pH of 5.0 to 4.7, residence of the leavened mixture at a temperature of 18° C. to 20° C. to a pH of 4.7 to 4.5, followed by packing. The microflora of the fungal leaven for kefir incorporates not only lactic-acid bacteria, but yeast as well; the optimum for the development of the microorganisms included in the composition of the fungal kefir leaven is within the range of from 18° C. to 26° C., which differs substantially from that for yoghurt leaven produced at 40° C. to 42° C., wherefore the character of the development of these cultures in protein-enriched milk after ultra filtration also differs substantially. Furthermore, upon elevation of the protein content in milk to over 7 to 15% by mass an adequate growth of the cultures incorporated in the kefir leaven (yeast) is not ensured. The fermentation process becomes extended in time, the product acquires a non-pronounced “empty” taste. Moreover, due to the long duration of the fermentation process in the final product proteolytic flaws appear: bitterness, foreign after-tastes. In this patent disclosure, the kefir is produced by fermenting a microflora of the fungal leaven at a temperature in the range of 18° C. to 26° C. and ultra filtered to remove kefir leavening. Kefir fungi comprise a natural symbiosis of the following microorganisms: lactic-acid streptococci, acetic-acid bacteria, lactic-acid bacilli and yeast both fermenting and non-fermenting lactose. This fermentation is done at the kefir factory due to the filtration requirement.

U.S. Pat. No. 5,827,552 to Mainzer et al. discloses production of fermented food products. This method of making fermented food products such as yogurt uses Lactobacillus bulgaricus organisms for making fermented food products which are conditionally sensitive, that is, operate to metabolize a desired compound normally under the processing conditions for fermented food products but slow or decrease in activity beyond what is normal under the routine storage temperatures for the fermented food products. Such fermented food products exhibits improved shelf life and long-term taste. The yogurt culture is a mutant Lactobacillus bulgaricus organism that has about 20% reduction of growth rate below 20° C. thereby reducing the formation of foul taste and texture in the cultured yogurt during storage.

U.S. Pat. No. 6,033,691 to Cravero discloses a process for manufacturing a biologically active fermented milk product and product obtained by the process. Lactobacillus casei (ATCC 55544) and Lactobacillus acidophilus (ATCC 55543) are simultaneously inoculated in milk previously added with Streptococcus, and then fermented at a temperature of 43° C. Fermentation results in the formation of a biologically active milk product. After fermentation, the resulting product can be stores between 4° C. and 10° C. for up to 30 days. Storage of the product does not require any special container. The product can also be lyophilized and stored at 20° C. to 25° C. (relative humidity 40 to 65%) for a minimum of four months. When reconstituted, the powdered product has a pH close to liquid and is palatable. The milk contains maltodextrin, non-fatty powder milk and sugar as well as carboxymethylcellulose stabilizers. The first simultaneous yogurt culture used is Lactobacillus casei (ATCC 55544) and Lactobacillus acidophilus (ATCC 55543) followed by Streptococcus. The milk used has maltodextrin, non-fatty powder milk and sugar as well as carboxymethylcellulose stabilizers and the yogurt formed can stay for four months without degradation at 20° C. to 25° C. The milk used is not free from additives and the yogurt formed does not need low temperature refrigeration.

U.S. Pat. No. 6,399,122 to Vandeweghe et al. discloses a yogurt production process. This process is for decreasing the time required for incubation of the yogurt. The acidity of yogurt decreases as the fermentation proceeds. The decrease in time is accomplished by merely adding acids chosen from citric acid, lactic acid, malic acid, gamma delta lactone, tartartic acid, and their combinations, instead of waiting for the completion of fermentation, thereby decreasing the yogurt formation time or production of yogurt without compromise to the final product quality. The yogurt fermentation is carried out at about 40.6° C. to 46.1° C. (105° F. to 115° F.) followed by direct acidification. The yogurt composition is directly acidified when the pH of the composition reaches a pH of about 4.8 to about 5.2. The yogurt fermentation uses Streptococcus thermophilus and Lactobacillus bulgaricus bacteria. The composition can be acidified while the temperature is at about 40.6° C. to 46.1° C. (105° F. to 115° F.), or the composition can be acidified during or after cooling. The acidification is carried out by adding citric acid, lactic acid, malic acid, gamma delta lactone, tartaric acid, and their combinations. This is a factory produced yogurt with acidifying additives.

U.S. Pat. No. 7,615,367 to De Vuyst et al. discloses Streptococcus thermophilus strains producing stable high-molecular-mass exopolysaccharides. The exopolysaccharide mass is produced by a lactic acid bacteria. The method uses culture media for producing large amounts of exopolysaccharides in safe and simple fermentation conditions. The Streptococcus thermophilus ST 111 strain produces a stable high-molecular-mass heteropolysaccharide, for use in functional starter cultures and for use in food fermentation processes such as processes producing milk products, yoghurt and cheese for texture improvement and decreasing syneresis during fermentation and in the fermented product. This high-molecular-mass exopolysaccharides is used as a starter culture for the inoculation of yogurt forming milk and fermentation of other food precuts. The '367 patent does not disclose incubation of yogurt or kefir.

Non-Patent Publication “Effect of Mixing During Fermentation in Yogurt Manufacturing” authors Aguirre-Ezkauriatza et al. from Journal of Dairy Science Dec. 1, 2008 available at http://jds.fass.org/cgi/reprint/92/9/4112.pdf discloses effect of mixing during fermentation in yogurt manufacturing. The yogurt starters, Lactobacillus delbrueckii ssp. bulgaricus and Streptococcus thermophilus, are well known facultatively anaerobic bacteria that can grow in oxygenated environments. Removing dissolved oxygen (DO) in a yogurt mix as the fermentation progressed is shown to retarded the production of acid. Yogurt fermentation was carried out at 43° C. or 37° C. both after the DO reduction treatment and without prior treatment. Nitrogen gas was mixed and dispersed into the yogurt mix after inoculation with yogurt starter culture to reduce the DO concentration in the yogurt mix. The combination of reduced DO concentration in the yogurt mix beforehand and incubation at a lower temperature (37° C.) is said to result in a superior set yogurt with a smooth texture and strong curd structure.

There remains a need in the art for a fresh yogurt or kefir product that is available to customers in a retail location wherein the yogurt or kefir has a high concentration of beneficial cultures. There is a need for a process and method of delivering to retail locations a completely sealed unfermented mixture that is capable of setting into a high quality tasty fresh yogurt having excellent texture when incubated at the retail location.

### SUMMARY OF THE INVENTION

The present invention provides a freshly cultured yogurt or kefir at a retail location that has undiminished content of active beneficial cultures. The yogurt has a fresh taste, free from bad flavors, and has an excellent texture representative of a superior ‘Grade A’ sealed yogurt or kefir product, and preferably is free from additives, thickeners or antibiotics or microbial growth retarding agents.

Briefly stated, the first embodiment of the invention involves a process that produces fresh yogurt in situ. More specifically, the process for producing fresh yogurt generally comprises the steps of: (i) sterilizing milk at a temperature in the range of 85° C. to 95° C. to kill all yeast present and to denature the protein structure of the milk suitable for culturing yogurt if sterilized milk is unavailable; (ii) cooling the milk to a low temperature in the range of 4° C. to 10° C.; (iii) adding a yogurt culture capable of long life in the 4° C. to 10° C. temperature range to cold milk; (iv) mixing said culture with said cold milk to form a mixture; (v) filling and sealing the mixture in a sterile container; (vi) transporting the containers with cold milk with yogurt culture to the retail store location and storing said containers at a temperature range of 4° C. to 10° C. for a time period ranging typically from one day to 30 days; (vi) removing the cold containers as needed from cold storage and heating the container in an oven to a temperature in the range of 40° C. to 45° C. for a period of 4 to 10 hours depending on the time and temperature setting properties of the yogurt culture; and (vii) placing said set yogurt in a refrigerating environment at a temperature of 4° C. to 10° C. for sale to customers at the retail store location. The yogurt thus produced is preferably free from antibiotics, acidifiers, thickeners bacterial growth retarding agents and other artificial additives. The process may further include a cooling and incubation chamber that can both cool for refrigeration and heat for setting the yogurt milk-yogurt culture mixture. The first embodiment requires the yogurt culture mixed in milk to tolerate 4° C. to 10° C. for prolonged time periods without producing off flavors or stringy yogurt. This property is met by Lactobacillus bulgaricus and Streptococcus thermophilus.

The second embodiment of the invention for producing fresh yogurt or kefir generally comprises the steps of: (i) sterilizing milk at a temperature in the range of 85° C. to 95° C. to kill all yeast present and to denature the protein structure of the milk suitable for culturing yogurt of kefir when sterilized milk is unavailable; (ii) cooling the milk to a low temperature in the range of 4° C. to 10° C.; (iii) filling and sealing the mixture in a sterile container with a lid having a separate compartment that contains yogurt of kefir culture kept away from the cold milk; (iv) transporting the sealed yogurt containers with cold milk with separated yogurt or kefir culture to the retail store location and storing said containers at a temperature range of 4° C. to 10° C. for a time period ranging up to 30 days; (v) removing the cold containers as needed from cold storage, shaking the contents to distribute the yogurt or kefir culture into the cold milk and heating the container in an oven to a temperature in the range of 33° C. to 45° C. for a period of 4 to 10 hours depending on the time and temperature yogurt setting properties of the yogurt or 18° C. to 25° C. for 10 to 20 hours for a kefir culture; and (vii) placing said set yogurt or kefir in a refrigerating environment at a temperature of 4° C. to 10° C. for sale to customers at the retail store location. Since the yogurt or kefir culture is separated from cold milk within the container, no off flavors or stringy texture are generated, and the yogurt culture can be any culture including low temperature setting Lactobacillus acidophilus and Lactobacillus bifidus.

Significant advantages are realized by practice of the present invention. In a preferred embodiment, the Process and System for Delivering Fresh Yogurt or Kefir of the present invention comprises the steps of:
1) heating the milk to sterilization temperature in the range of 85° C. to 95° C. when sterilized milk is unavailable;
2) cooling the sterilized milk to a temperature in the range of 4° C. to 10° C.;
3) In the first embodiment, mixing the cooled milk with yogurt forming cultures of Lactobacillus bulgaricus and Streptococcus thermophilus, both being selected for low growth characteristics in the temperature range of 4° C. to 10° C.;
   a. filling cold milk-yogurt culture mixture in sterile yogurt containers and sealing with a lid;
   b. transporting sealed containers of milk-yogurt culture mixture in refrigerated trucks held at 4° C. to 10° C. to retail store outlets;
   c. retail stores storing said sealed yogurt containers of milk-yogurt culture mixture in a refrigeration equipment set at a temperature range of 4° C. to 10° C.;
   d. when fresh yogurt is needed transferring the containers milk-yogurt culture mixture to an oven set at a temperature in the range of 33° C. to 45° C. and incubating the yogurt mixture for 4 to 10 hours, completely setting the yogurt;
   e. transferring said set yogurt to a refrigeration equipment set at a temperature range of 4° C. to 10° C. for sale to customers at the retail location;
4) In the second embodiment, filling said cooled milk into sterile sealed containers, said containers having an internal second compartment;
   a. said compartment receiving high temperature incubating or low temperature incubating yogurt culture and being kept separate from cold milk in a open top or breakable/dissolvable top containment for dispensing yogurt or kefir culture into cold milk prior to incubation;
   b. transporting sealed containers of milk-separated yogurt culture in refrigerated trucks held at 4° C. to 10° C. to retail store outlets;
   c. storing said sealed containers of milk-separated yogurt culture in refrigeration equipment set at a temperature range of 4° C. to 10° C.;
   d. when fresh yogurt is needed transferring the containers milk-separated yogurt culture and shaking the contents to form a mixture and transferring to an oven set at a temperature in the range of 18° C. to 25° C. for kefir yogurt culture or 33° C. to 45° C. for Lactobacillus bulgaricus and Streptococcus thermophilus or other yogurt culture, and incubating the yogurt mixture for 10-15 hours for kefir or 4 to 10 hours for yogurt, completely setting the kefir or yogurt product;
   e. transferring said set yogurt to refrigeration equipment set at a temperature range of 4° C. to 10° C. for sale to customers at the retail location;

whereby the fresh yogurt or kefir is freshly prepared with no additives such as antibiotics, thickeners, vegetable gums, corn starch or other additives with digestive friendly cultures available at full concentration without culture cell count reduction due to age of yogurt.

### BRIEF DESCRIPTION OF THE DRAWING

The invention will be more fully understood and further advantages will become apparent when reference is had to the following detailed description of the preferred embodiments of the invention and the accompanying drawing, in which:

FIG. 1 schematically illustrates the flow chart for the manufacturing and dispensing of fresh yogurt at a retail location according to the first embodiment of the invention;

FIG. 2 schematically illustrates the second embodiment of the invention wherein the yogurt or kefir culture is maintained separate from the cold milk during transportation and storage at the retail location;

FIG. 3 illustrates a commercial refrigeration unit that provides heating for yogurt or kefir incubation and cooling for storage of cultured yogurt or kefir prior to sale.

### DETAILED DESCRIPTION OF THE INVENTION

Yogurt is actually a fermented milk product. The milk is fermented using bacteria such as Lactobacillus bulgaricus. In some yogurt production there might be involved more than one type of bacteria such as Streptococcus thermophilus. The Lactobacillus bacteria are fermentative bacteria that convert lactose, the sugar in the milk, into lactic acids causing the characteristic curd to form. They can tolerate the presence of oxygen. The acid also restricts the growth of food poisoning bacteria. During the yogurt fermentation some flavors are produced, which give yogurt its characteristic acetaldehyde flavor. Yogurt is a fermented food derived from the fermentation of milk. A commercially produced yogurt is made up of milk, sugars, stabilizers, fruits and flavors, and a bacterial culture Lactobacillus bulgaricus. The fermentation of yogurt is approximately about 4 hours. A completely fermented yogurt has a pH of about 4.4, which value is within the acid range. The process for manufacturing prior art commercial yogurt typically involves the following steps:
1. Whole milk or partially skimmed milk fortified with nonfat dry milk (up to 3%) is pasteurized or heat treated and then cooled to 37.8° C. to 43.3° C. (100° F. to 110° F.).
2. The heat treated milk is inoculated with coccus (Streptococcus thermophilus), and rod (Lactobacillus bulgaricus) culture. Preferably, the coccus to rod ratio of the culture prior to inoculation is 1:1. Also, most generally the starter culture used is a frozen concentrate purchased from a commercial source. In some commercial preparation plants, a bulk starter medium is prepared by reconstituting nonfat dry milk solids in water, heating to 87.8° C. (190° F.) for 1 hour, cooling to 37.8° C. to 43.3° C. (100° F. to 110° F.), and inoculating coccus and rod frozen culture. The medium is incubated until pH drops to from 4.2 to 4.5 and then cooled to 4.4° C. to 7.2° C. (40° F. to 45° F.). This bulk culture is inoculated into yogurt mix at the rate of 1 to 2%.
3. The coccus and rod inoculated mix is incubated at 37.8° C. to 45° C. (100° F. to 113° F.). until pH drops from 6.6 to 6.0. At this stage, the yogurt mix is pumped into a dispenser and it is dispensed into a cup with fruit preserve at the bottom.
4. The cups are sealed and moved into a warm room 37.8° C. to 45.6° C. (100° F. to 114° F.) and held until pH drops to 4.8. Then the cups are placed in a cooler environment until the yogurt is cooled to 4.4° C. (40° F.). By then the pH of the final product is 4.0 to 4.4.

The most important component in controlling the quality of yogurt fermentation is temperature. Temperature affects the yogurt fermentation by controlling the growth rate of the microorganism. If the temperature is too low, the culture grows too slowly to adequately acidify milk and to achieve a good texture. The commercial starter is a mixed culture of Streptococcus thermophilus and Lactobacillus bulgaricus. If the temperature is too high, it might end up killing the cultures. Temperature will affect the taste of the yogurt produced at the formation and secretion of metabolites which contribute to the overall taste are dependent on the growth rate. The window of proper fermentation is quite small, i.e. from 42° C. to 44° C. In general, as the temperature is raised up to 44° C., the rate of culture metabolism is higher, and the yogurt is sweeter. Faster growth also prompts the yogurt to set faster. When the desired acidity is reached, yogurt is quickly cooled to halt further fermentation and metabolic activity. This cooling step is quite critical in industrial yogurt production; it must be done quickly to control tightly the acidity of the yogurt, which has a profound effect on the taste. The yogurt cultures are varied and some representative strains are Streptococcus lactis, Streptococcus cremoris, Streptococcus thermophilus, Lactobacillus bulgaricus, Lactobacillus acidophilus, and Lactobacillus plantarum. Commercial yogurt production is composed of pretreatment of milk (standardization, fortification, lactose hydrolysis), homogenization, heat treatment, cooling to incubation temperature, inoculation with starter, fermentation, cooling, post-fermentation treatment (flavoring, fruit addition, pasteurization), refrigeration/freezing, and packaging. For set yogurt, the packaging into individual containers is carried out before fermentation.

Typically, yogurt is produced in a plant that mixes cooled sterilized milk with bacteria. The yogurt bacteria mixture is incubated for several hours and allowed to cool. The milk is first sterilized by heating to approximately 93° C. and is kept at this temperature for 10-30 minutes, depending upon the yogurt thickness desired. For thicker yogurt, the milk is heated longer evaporating more of the water content. Next, the milk is rapidly cooled to approximately 44° C. and mixed with a yogurt starter, which contains the necessary bacteria. This dairy mixture is placed in clean containers and incubated for a minimum of four hours at 37° C. To stop the incubation, the yogurt is placed in a cool environment such as a refrigerator. Yogurt produced by this process is packaged and delivered to various stores and is stored in a refrigerator, where it is offered for sale. The bacteria containing yogurt has a shelf life of approximately 60 days. Bacteria content present in yogurt decreases significantly after 7 days. For this reason, fresh yogurt is healthier for the consumer. The higher bacteria count is better for the upper and lower digestive system. Often times, due to shipping and delivery of yogurt products, by the time it gets to the store or point of purchase, the yogurt is no longer fresh. Consequently, there is a need in the art for a process that would provide yogurt having the ability to be served fresh. An objective of this invention is to provide a process that yields fresh yogurt. The process of the present invention enables yogurt to be produced at lower cost (less need to ship every day) and less handling of the yogurt containing cups is required. Yogurt produced by the process of this invention is fresher. It therefore not only tastes better, but also is healthier.

This invention relates to a method of providing freshly cultured yogurt or kefir with a high level of healthy probiotic bacterial cultures. The incubation of the yogurt is carried out at the retail yogurt dispensing location just prior to sale of the yogurt contained within a sealed container. Since the milk prior to yogurt or kefir incubation is sterilized by high temperature heating and is sealed and stored in a sterile container throughout the product cycle, the sealed containers of fresh yogurt or kefir receives a ‘Grade A’ rating. The first embodiment of the process takes advantage of thermophillic yogurt such as Streptococcus thermophilus and Lactobacillus bulgaricus cultures that tolerate high incubation temperatures in the range of 33° C. to 45° C. and have very little yogurt culture growth and formation of bad taste and texture when shipped and/or stored as an intimate mixture in a sealed container at temperatures in the range of 4° C. to 10° C. The second embodiment of the process takes advantage of sensitive organisms which may multiply at low temperatures in the range of 4° C. to 10° C. such as kefir culture that grows even at low temperatures and has an incubation temperature in the range of 18° C. to 25° C. for a period of 16 hours and prolonged incubation creates off flavors and texture. In this case, the sterilized cold milk is shipped within the sealed container which has a physically separated region that has the kefir culture and are brought together just prior to incubation of the yogurt. During the time that the yogurt mixture is incubating it must be kept very still, as jostling of the mixture tends to destroy the active culture and causes the yogurt to crack.

Briefly stated, the first embodiment of the invention involves a process that produces fresh yogurt in situ. More specifically, the process for producing fresh yogurt generally comprises the steps of: (i) sterilizing milk at a temperature in the range of 85° C. to 95° C. to kill all yeast present and to denature the protein structure of the milk suitable for culturing yogurt of kefir if sterilized milk is not available; (ii) cooling the milk to a low temperature in the range of 4° C. to 10° C.; (iii) adding a yogurt culture capable of long life in the 4° C. to 10° C. temperature range to cold milk; (iv) mixing said culture with said cold milk to form a mixture; (v) filling and sealing the mixture in a sterile container; (vi) transporting the containers with cold milk with inoculated yogurt culture to the retail store location and storing said containers at a temperature range of 4° C. to 10° C. for a time period ranging from one day to 30 days; (vi) removing the cold containers as needed from cold storage and heating the container in an oven to a temperature in the range of 33° C. to 45° C. for a period of 4 to 10 hours depending on the time and temperature yogurt setting properties of the yogurt or kefir culture; and (vii) placing said set yogurt or kefir in a refrigerating environment at a temperature of 4° C. to 10° C. for sale to customers at the retail store location. The yogurt thus produced is free from antibiotics, acidifiers, thickeners bacterial growth retarding agents and other artificial additives. The process may further include a cooling and incubation chamber that can both heat for setting the yogurt milk-yogurt culture and cool for refrigerated storage after yogurt setting. The first embodiment requires the yogurt culture mixed in milk to tolerate 4° C. to 10° C. for prolonged time periods without yogurt culture growth producing off flavors or stringy yogurt.

Briefly stated, the second embodiment of the invention for producing fresh yogurt or kefir generally comprises the steps of: (i) sterilizing milk at a temperature in the range of 85° C. to 95° C. to kill all yeast present and to denature the protein structure of the milk suitable for culturing yogurt of kefir if sterilized milk is unavailable; (ii) cooling the milk to a low temperature in the range of 4° C. to 10° C.; (iii) filling and sealing the cooled milk in a sterile yogurt container with a lid having a separate compartment that contains yogurt of kefir culture kept away from the cold milk; (iv) transporting the yogurt containers with cold milk with separated yogurt or kefir culture to the retail store location and storing said containers at a temperature range of 4° C. to 10° C. for a time period up to 30 days; (v) removing the cold containers as needed from cold storage, shaking the contents to distribute the yogurt or kefir culture into the cold milk and heating the container in an oven to a temperature in the range of 40° C. to 45° C. for a period of 4 to 10 hours for yogurt culture and 18° C. to 25° C. for 10-20 hours for kefir culture depending on the time and temperature yogurt or kefir culture setting properties; and (vii) placing said set yogurt or kefir in a refrigerating environment at a temperature of 4° C. to 10° C. for sale to customers at the retail store location. Since the yogurt or kefir culture is separated from cold milk within the container during transportation and storage at the retail location, no off flavors or stringy textures are generated.

The storage, heating to incubation temperature and final cooling down after the yogurt or kefir has set can be carried out using three separate units or a single unit capable of cycling through the temperature cycles for specified time periods. In this case, the entire process takes place in situ, with the result that the yogurt is fresh for consumption at the store on the very next day. Quality of the yogurt is improved by eliminating separation which may otherwise occur during portage. Advertising options applicable to this process would include, for example, a sign indicating that the yogurt is incubating, and would be ready in 2 hours. Options exist, such as small heating and cooling units for production of yogurt in situ at the customer's residence.

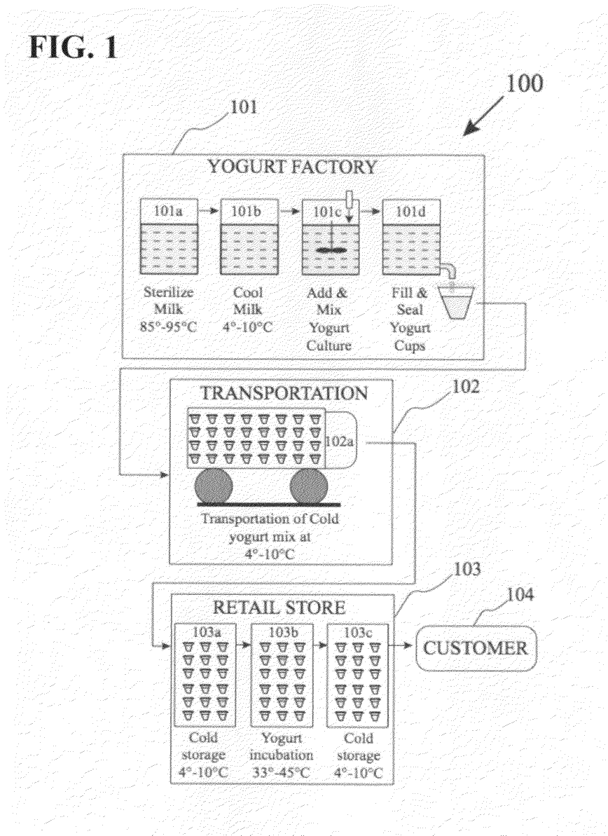

FIG. 1 illustrates the flow chart of the first embodiment of the process of the fresh yogurt, shown generally at 100. The yogurt manufacturing factory is shown at 101. Step 101a sterilizes the milk received to kill all the yeast contamination, which can produce sour taste and gassy yogurt. This sterilization step generally requires a temperature in the range of 85° C. to 95° C. If sterilized milk is available this step may be omitted. In step 101b, the sterilized milk is cooled to 4° C. to 10° C. In step 101c, the yogurt culture of Streptococcus thermophilus and Lactobacillus bulgaricus which has very little growth rate at 4° C. to 10° C. temperature range is mixed into the milk. In step 101d, the yogurt mixture containing yogurt culture is fed to individual yogurt cups and sealed in the yogurt factory. This sealed containers of yogurt mixture when incubated at the retail store location produces a ‘Grade A’ certified yogurt, since the yogurt containers have never been opened. The filled sealed yogurt containers are transported to retail store locations in a refrigerated truck maintained at 4° C. to 10° C. temperature as shown in step 102. Due to the reduced growth characteristic of the Streptococcus thermophilus and Lactobacillus bulgaricus yogurt cultures, the yogurt mixture does not develop foul taste or flavor. The refrigerated truck delivers the sealed yogurt containers with yogurt mixture to retail store locations as shown at step 103. The retail store uses a refrigerator to store the sealed yogurt containers with yogurt mixture for a period up to 30 days as shown in step 103a. The merchant of the retail store decides how many yogurt containers must be incubated and transfers the selected yogurt containers into the incubation oven. The yogurt is incubated according to the known yogurt setting characteristics of the yogurt culture, which is typically 33° C. to 45° C. for 4 to 10 hours as shown in step 103b. The yogurt containers are next transferred to the refrigerated unit maintained at 4° C. to 10° C. and is ready for sale to a customer. The setting characteristics of the yogurt may be verified by opening a sealed yogurt container.

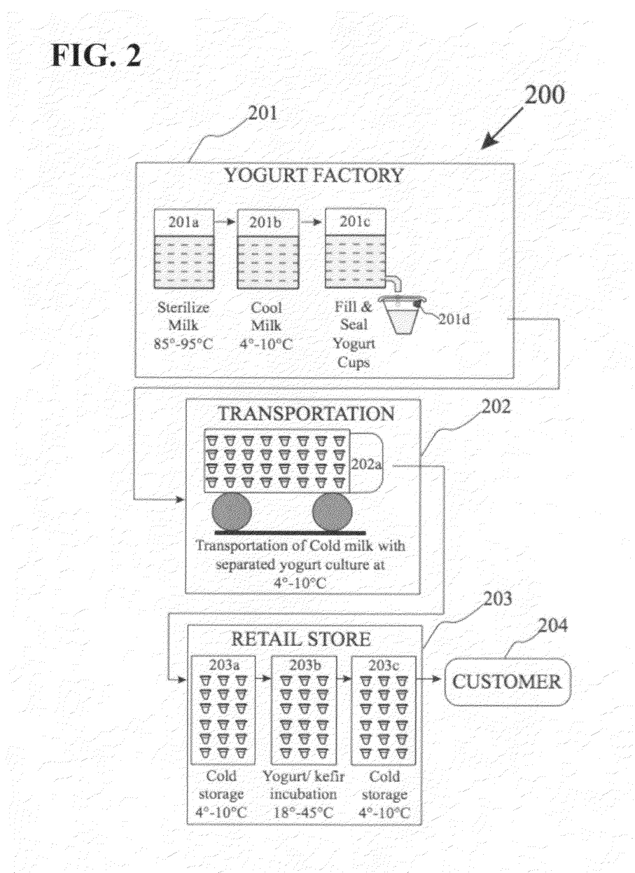

FIG. 2 illustrates the flow chart of the second embodiment of the process of the fresh yogurt, shown generally at 200. The yogurt manufacturing factory is shown at 201. Step 201a sterilizes the milk received to kill all the yeast contamination, which can produce sour taste and gassy yogurt. This sterilization step generally requires a temperature in the range of 85° C. to 95° C. If sterilized milk is available this step may be omitted. In step 201b, the sterilized milk is cooled to 4° C. to 10° C. In step 201c, the cold milk is fed to individual yogurt cups that have a recessed partition portion 201d with an open top, breakable or dissolvable top that is previously filled with the yogurt or kefir culture. After filling the yogurt container with milk, the container is sealed at the yogurt factory with a lid. Since the yogurt or kefir culture and milk are physically separate there is no possibility of growth of microorganisms in a manner similar to shipped cold milk. This second embodiment can take advantage of all the varieties of yogurt or kefir cultures including the low temperature setting yogurt cultures. Typical yogurt cultures include Lactobacillus acidophilus, Lactobacillus bifidus, Lactobacillus casei, Lactobacillus bulgaricus, Lactobacillus plantarum, Streptococcus thermophilus and mutant cultures. This sealed containers of milk with separated yogurt culture when mixed and incubated at retail store location produces a ‘Grade A’ certified yogurt, since the yogurt containers have never been opened. The filled sealed yogurt containers are transported in a refrigerated truck maintained at 4° C. to 10° C. temperature as shown in step 202. The refrigerated truck delivers the sealed yogurt containers with milk and separated yogurt or kefir culture to retail store locations as shown at step 203. The retail store uses a refrigerator to store the sealed yogurt containers for a period up to 30 days as shown in step 203a. The merchant of the retail store decides how many yogurt containers must be incubated and transfers the selected yogurt containers into the incubation oven after shaking the yogurt containers to mix the yogurt or kefir culture contained in 201d with the milk intimately. The yogurt mixture is incubated according to the known yogurt setting characteristics of the yogurt culture, which is quite varied. Streptococcus thermophilus and Lactobacillus bulgaricus culture typically requires 33° C. to 45° C. for 4 to 10 hours and Lactobacillus acidophilus and other yogurt cultures requires lower incubation temperatures.

Kefir culture requires 18° C. to 25° C. for 10 to 20 hours as shown in step 203b. The yogurt containers are next transferred to the refrigerated unit maintained at 4° C. to 10° C. and is ready for sale to a customer. The setting characteristics of the yogurt may be verified by opening a sealed yogurt container.

The transportation truck should be vibration isolated to prevent excessive shaking of the yogurt containers produced according to the second embodiment. While FIG. 2 shows the yogurt or kefir containment as an open top partition, other means may be used equally well. This may include a gelatin capsule filled with yogurt or kefir culture wherein the gelatin capsule will dissolve when the yogurt container is shaken at the retail store location. Other separation means may be used equally effectively. In all cases, the sealed cap of the yogurt container must not be opened since this action destroys the ‘Grade A’ rating of the yogurt.

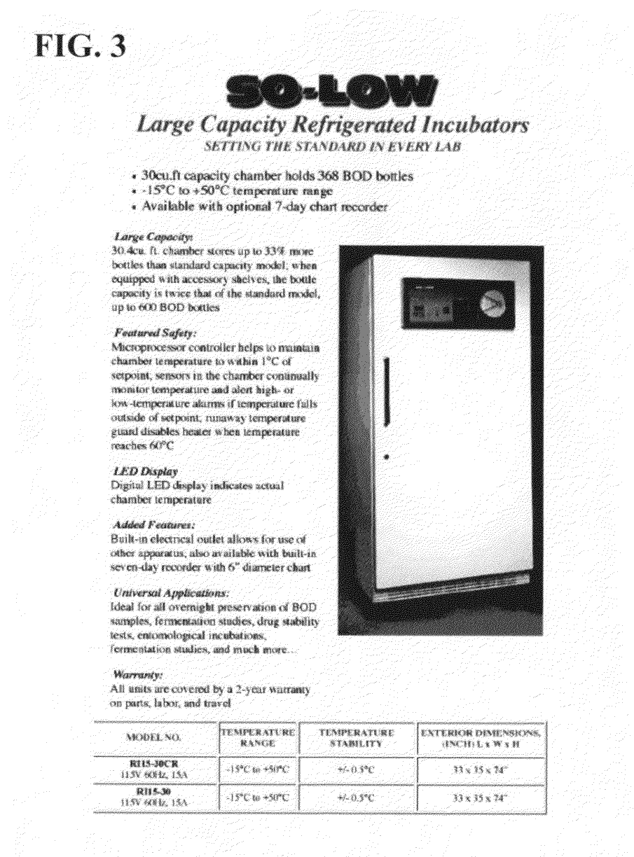

FIG. 3 illustrates a combination refrigeration incubation unit discussed at web page http://www.startracksmedical.com/solow/ovenfurnace/lrgrefincu.htm. The refrigerator/incubator is programmable and executes time temperature cycle. The combination refrigeration incubation unit may be used for storing received yogurt mixture, incubating and storing finished cooled yogurt or kefir for sale. On the other hand, the combination refrigeration incubation unit may be used only for incubation of yogurt and cooling it for storage or display of finished yogurt or kefir for sale.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1) A process for delivery of fresh yogurt at a retail location comprising the steps of:
a) cooling sterilized milk to a temperature in the range of 4° C. to 10° C.;
b) mixing said cooled milk with yogurt forming cultures having reduced growth rate in the 4° C. to 10° C. temperature range, forming a yogurt culture mixture;
c) filling the yogurt culture mixture in sterile yogurt containers and sealing with a lid;
d) transporting said sealed yogurt containers in refrigerated trucks held at 4° C. to 10° C. to retail store outlets;
e) storing said sealed yogurt containers in refrigeration equipment set at a temperature range of 4° C. to 10° C. in said retail stores;
f) transferring the yogurt containers to an oven at said retail location, said oven being set at a temperature in the range of 33° C. to 45° C. when fresh yogurt is needed and incubating the yogurt mixture for 4 to 10 hours, completely setting the yogurt;
g) transferring said set yogurt to a refrigeration equipment at said retail location, said refrigeration equipment being set at a temperature range of 4° C. to 10° C., and said yogurt being retained therein for sale to customers at the retail location;
whereby the yogurt is freshly prepared with no additives including antibiotics, thickeners, vegetable gums, corn starch or other additives having a full concentration of digestive friendly cultures without culture cell count reduction due to age of yogurt.

2) The process for delivery of fresh yogurt at a retail location as recited by claim 1, wherein said sterilized milk is produced by heating milk to a sterilization temperature in the range of 85° C. to 95° C. killing yeast and denaturing milk proteins when sterilized milk is unavailable.

3) The process for delivery of fresh yogurt at a retail location as recited by claim 1, wherein said yogurt forming cultures with reduced growth rate in the 4° C. to 10° C. temperature range is Lactobacillus bulgaricus and Streptococcus thermophilus.

4) The process for delivery of fresh yogurt at a retail location as recited by claim 1, wherein said yogurt mixture prior to incubation is stable for up to 30 days.

5) The process for delivery of fresh yogurt at a retail location as recited by claim 1, wherein said set yogurt is free from foul taste, poor texture or ropiness.

6) The process for delivery of fresh yogurt at a retail location as recited by claim 1, wherein said storage of delivered yogurt containers, incubation and storage of finished set yogurt is carried out in a refrigeration incubation unit set for time-temperature cycle.

7) The process for delivery of fresh yogurt at a retail location as recited by claim 1, wherein said incubation of delivered yogurt containers, and storage of finished set yogurt is carried out in a refrigeration incubation unit set for time-temperature cycle.

8) A process for delivery of fresh yogurt at a retail location comprising the steps of:
a) cooling said sterilized milk to a temperature in the range of 4° C. to 10° C.;
b) filling said cooled milk in sterile yogurt container having an internal second compartment;
c) said internal compartment having an open top, a breakable top or dissolvable top containing yogurt or kefir culture kept separated from said filled cooled milk;
d) sealing said sterile yogurt containers with a lid;
e) transporting said sealed yogurt containers in refrigerated trucks held at 4° C. to 10° C. to retail store locations;
f) storing said sealed yogurt containers in a refrigeration equipment set at a temperature range of 4° C. to 10° C. in said retail stores;
g) shaking the yogurt container at said retail location to mix yogurt or kefir culture with cooled milk forming yogurt mixture when fresh yogurt is needed;
h) transferring the yogurt containers to an oven at said retail location, said oven being set at a temperature appropriate for incubating the yogurt mixture for 4 to 20 hours, completely setting the yogurt or kefir;
i) transferring said set yogurt or kefir to refrigeration equipment at said retail location, said refrigeration equipment being set at a temperature range of 4° C. to 10° C. for sale to customers at the retail location;
whereby the yogurt or kefir is freshly prepared with no additives including antibiotics, thickeners, vegetable gums, corn starch or other additives having a full concentration of digestive friendly cultures without culture cell count reduction due to age of yogurt or kefir.

9) The process for delivery of fresh yogurt at a retail location as recited by claim 8, wherein said sterilized milk is produced by heating milk to sterilization temperature in the range of 85° C. to 95° C. killing yeast and denaturing milk proteins when sterilized milk is unavailable.

10) The process for delivery of fresh yogurt at a retail location as recited by claim 8, wherein said cooled milk and separated yogurt or kefir culture prior to incubation is stable for up to 30 days.

11) The process for delivery of fresh yogurt at a retail location as recited by claim 8, wherein said set yogurt or kefir is free from foul taste, poor texture or ropiness.

12) The process for delivery of fresh yogurt at a retail location as recited by claim 8, wherein the yogurt or kefir culture is selected from Lactobacillus acidophilus, Lactobacillus bifidus, Lactobacillus casei, Lactobacillus bulgaricus, Lactobacillus plantarum, Streptococcus thermophilus mutant cultures and kefir culture.

13) The process for delivery of fresh yogurt at a retail location as recited by claim 8, wherein the kefir culture is incubated at 18° C. to 25° C. for 10 to 20 hours.

14) The process for delivery of fresh yogurt at a retail location as recited by claim 8, wherein said storage of delivered yogurt containers, incubation and storage of finished set yogurt is carried out in a refrigeration incubation unit set for time-temperature cycle.

15) The process for delivery of fresh yogurt at a retail location as recited by claim 1, wherein said incubation of delivered yogurt containers, and storage of finished set yogurt is carried out in a refrigeration incubation unit set for time-temperature cycle.
